(19) United States
(12) Patent Application Publication
(10) Pub. No.: US 2016/0250913 A1
(43) Pub. Date: Sep. 1, 2016

(54) WINDSHIELD AND SEALING ELEMENT

(71) Applicant: Saint-Gobain Glass France, Courbevouie (FR)

(72) Inventors: Changle LI, Shanghai (CN); Guangji CHEN, Shanghai (CN)

(21) Appl. No.: 15/032,911

(22) PCT Filed: Oct. 29, 2014
(86) PCT No.: PCT/CN2014/089800

§ 371 Date: Apr. 28, 2016

(30) Foreign Application Priority Data
Oct. 30, 2013 (CN) 201310526481.5

(51) Int. Cl. B60J 10/70; B60J 10/20

(52) U.S. Cl. CPC B60J 10/70; B60J 10/20

(57) ABSTRACT

A windshield and a sealing element are provided. The sealing element includes a supporting part secured to an edge of the glass substrate and a sealing part integrated with the supporting part, viewing from a cross-sectional perspective of the windshield, the sealing part being substantially configured with a semicircle or semielliptical shape, wherein the supporting part and the sealing part define therebetween a space to allow the sealing part to deform when being fixed into the opening. The windshield includes a glass substrate and the sealing element. In the present disclosure, difficulty of fabricating a windshield may be decreased.

### CROSS-REFERENCE TO RELATED APPLICATIONS

The present application claims priority to Chinese Patent Application No. 201310526481.5, filed on Oct. 30, 2013, and entitled “WINDSHIELD AND SEALING ELEMENT”, and the entire disclosure of which is incorporated herein by reference.

### TECHNICAL FIELD

The present disclosure generally relates to vehicle field, and more particularly, to a windshield and a sealing element.

### BACKGROUND

To obtain good sealing effect, a windshield should be well matched with a bodywork of a vehicle, so that the windshield and the bodywork of the vehicle can be fixed together.

The windshield generally includes a glass substrate and a sealing element disposed between the bodywork of the vehicle and the glass substrate. The sealing element enables the bodywork of the vehicle to better accommodate the glass substrate, so that the glass substrate can be well fixed into the bodywork of the vehicle.

Chinese patent publication No. CN1452568B discloses “application of a window glass which includes a profiled bead for installing the window glass into a window opening”. FIG. 1 illustrates an example of a window glass disclosed in the above referenced Chinese patent. Specifically, the window glass may be a windshield, including a glass substrate 12 fixed in an opening 14 of a bodywork of a vehicle. The window glass further includes a profiled bead 13 that is fixed on a main surface of the glass substrate 12 for installing the glass substrate 12 with the bodywork of the vehicle. The main surface of the glass substrate 12 faces toward an interior of the vehicle during installation of the glass substrate 12. The profiled bead 13 includes a deformable lip 16 protruding from an edge of the window glass. After the glass substrate 12 is fixed into the opening 14 of the vehicle, the deformable lip 16 resists against a sheet metal of the opening 14 and thus becomes curved, thereby realizing sealing gaps between the window glass and the bodywork of the vehicle.

In existing techniques, other than the deformable lip 16 illustrated in FIG. 1, there are variety of other sealing elements used for vehicular window sealing.

However, with the development of vehicle technology and growing demand for better life quality, more requirements are proposed on sealing elements used for vehicular windows, such as easy installation, beautiful exterior, less wind noise and reduced pollution.

### SUMMARY

Embodiments of the disclosure provide windshields and sealing elements, which can be manufactured more easily.

In one aspect, a windshield, adapted for being fixed into an opening framed by a bodywork of the vehicle, is provided. The windshield includes: a glass substrate; and a sealing element, including a supporting part secured to an edge of the glass substrate and a sealing part being integrated with the supporting part, viewing from a cross-sectional perspective of the windshield, the sealing part being substantially configured with a semicircle or semielliptical shape, and the supporting part and the sealing part defining therebetween a space to allow the sealing part to deform when being fixed into the opening.

A basic principle lies in that the space defined by the supporting part and the sealing part may undergo deformation when the windshield is being fixed into the opening. The space provides installation tolerance for the windshield, so that requirements for a strict matching between a shape of the glass substrate and a shape of the bodywork of the vehicle, and for a strict matching between a size of the glass substrate and a size of the vehicle, may no longer be necessary, which further decreases difficulty of fabricating the windshield.

Further, viewing from the cross-sectional perspective of the windshield, the sealing part is substantially configured with a semicircle or semielliptical shape, which enables the sealing element to uniformly bear forces when the windshield is being fixed into the opening and further improves alignment during installation of the windshield.

Further, compared with the sealing structure in FIG. 1, in an embodiment, a surface of the sealing part which faces an exterior of the vehicle can be aligned with a surface of a sheet metal. Benefits brought by this feature may include: gaps between the windshield and the sheet metal can be better sealed, which may reduce wind noise and eliminate spaces for accumulating rains or pollution. Besides, the appearance of the whole structure may be better.

In another aspect, a sealing element for use with a windshield is provided. The windshield is adapted for being fixed into an opening framed by a bodywork of a vehicle, and includes a glass substrate. The sealing element includes: a supporting part secured to an edge of the glass substrate; and a sealing part being integrated with the supporting part, viewing from a cross-sectional perspective of the windshield, the sealing part being substantially configured with a semicircle or semielliptical shape, wherein the supporting part and the sealing part define therebetween a space to allow the sealing part to deform when being fixed into the opening.

A basic principle lies in that the space defined by the supporting part and the sealing part may undergo deformation when the windshield is being fixed into the opening. The space provides installation tolerance for the windshield, so that requirements for a strict matching between a shape of the glass substrate and a shape of the bodywork of the vehicle, and for a strict matching between a size of the glass substrate and a size of the vehicle, may no longer be necessary, which further decreases difficulty of fabricating the windshield.

Further, viewing from the cross-sectional perspective of the windshield, the sealing part is substantially configured with a semicircle or semielliptical shape, which enables the sealing element to uniformly bear forces when the windshield is fixed into the opening and further improves alignment during installation of the windshield.

Further, compared with the sealing structure in FIG. 1, in an embodiment, a surface of the sealing part which faces an exterior of the vehicle can be aligned with a surface of a sheet metal. Benefits brought by this feature may include: gaps between the windshield and the sheet metal can be better sealed, which may reduce wind noise and eliminate spaces for accumulating rains or pollution. Besides, the appearance of the whole structure may be better.

### BRIEF DESCRIPTION OF THE DRAWINGS

FIG. 1 schematically illustrates a window glass in existing techniques;

FIG. 2 schematically illustrates a windshield according to one embodiment of the present disclosure;

FIG. 3 schematically illustrates a first example of a sealing element included in the windshield shown in FIG. 2 before installation;

FIG. 4 schematically illustrates the sealing element shown in FIG. 3 after installation;

FIG. 5 schematically illustrates a second example of a sealing element included in the windshield shown in FIG. 2 before installation;

FIG. 6 schematically illustrates the sealing element shown in FIG. 5 after installation; and

FIG. 7 schematically illustrates a third example of a sealing element included in the windshield shown in FIG. 2 before installation.

### DETAILED DESCRIPTION

The above objects, characteristics and advantages of the disclosure may be better understood by referring to the following description in conjunction with accompanying figures.

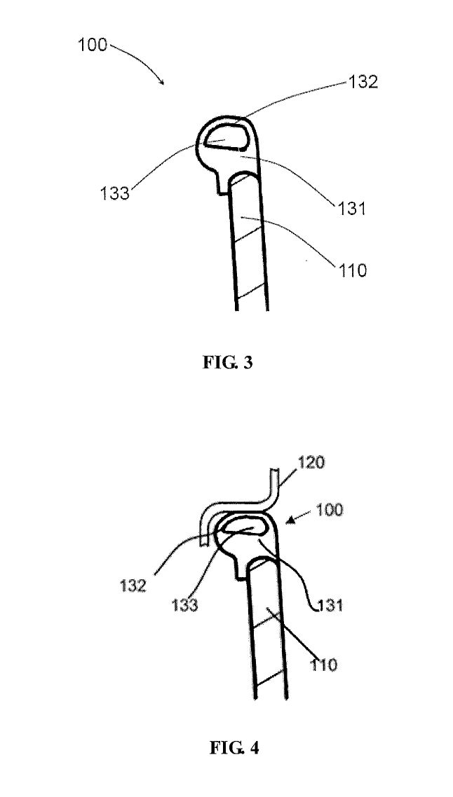

In an embodiment, a windshield is provided. FIG. 2 schematically illustrates a windshield according to one embodiment of the present disclosure, FIG. 3 schematically illustrates a first example of a sealing element included in the windshield shown in FIG. 2 before installation, and FIG. 4 schematically illustrates the sealing element shown in FIG. 3 after installation. It should be noted that, FIGS. 2 to 4 are schematic views along the cross section of the windshield.

Referring to FIGS. 2 to 4, in the embodiment, the windshield is fixed into an opening framed by a bodywork of the vehicle. Specifically, the opening is framed by a sheet metal 120 of the bodywork of the vehicle and the windshield is fixed into the sheet metal 120. In the embodiment, the windshield includes a glass substrate 110 and a sealing element 100.

The glass substrate 110 has a shape and a size which are matched with the opening framed by the sheet metal 120. In some embodiments, the shape of the glass substrate 110 may be a trapezoid with round corners.

In some embodiments, the glass substrate 110 may be a tempered glass or a semi-tempered glass. In some embodiments, the glass substrate 110 may be a laminated-layer glass or a single-layer glass. A material and a structure of the glass substrate 110 are not limited here.

The sealing element 100 is disposed at an edge of the glass substrate 110 and adapted for sealing gaps between the glass substrate 110 and the sheet metal 120 when the windshield is being fixed into the opening. In some embodiment, the sealing element 100 may be a sealing strip surrounding the edge of the glass substrate 110, which is not limited here.

Referring to FIGS. 3 and 4, the sealing element 100 includes a supporting part 131 and a sealing part 132.

The supporting part 131 is secured to the edge of the glass substrate 110 and adapted for fixing the sealing element 100 and the glass substrate 110.

In the embodiment, the supporting part 131 includes a channel at a side thereof facing toward the glass substrate 110. The channel is adapted for receiving the edge of the glass substrate 110. In some embodiments, a first adhering film (not shown in figures) may be formed in the channel, and the supporting part 131 may be secured to the edge of the glass substrate 110 through the first adhering layer.

The sealing part 132 is integrated with the supporting part 131. Viewing from a cross-sectional perspective of the windshield, the sealing part 132 is substantially configured with a semicircle or semielliptical shape. Viewing from the cross-sectional perspective of the windshield means viewing the cross-section of the structure which is on a plane perpendicular to the windshield. When the windshield is being fixed into the opening, the sealing part 132 faces toward the sheet metal 120. Due to the shape of the sealing part 132, it may contact with the sheet metal 120 on its curved surface to realize sealing the gaps between the glass substrate 110 and the sheet metal 120.

In some embodiments, viewing from the cross-sectional perspective of the windshield, the sealing part 132 is substantially configured with a semicircle or semielliptical shape, which enables the sealing element 132 to uniformly bear forces when the windshield is being fixed into the opening and further improves alignment during installation of the windshield.

In some embodiments, the sealing part 132 may be made of a material softer relative to a material of the supporting part 131, so that flexibility of the sealing part 132 is greater than that of the supporting part 131. When contacting with the sheet metal 120, the sealing part 132 is prone to deform, thereby realizing sealing the gaps between the glass substrate 110 and the sheet metal 120. In some embodiments, the sealing part 132 may include thermoplastic elastomer, and the supporting part 131 may include polyvinyl chloride.

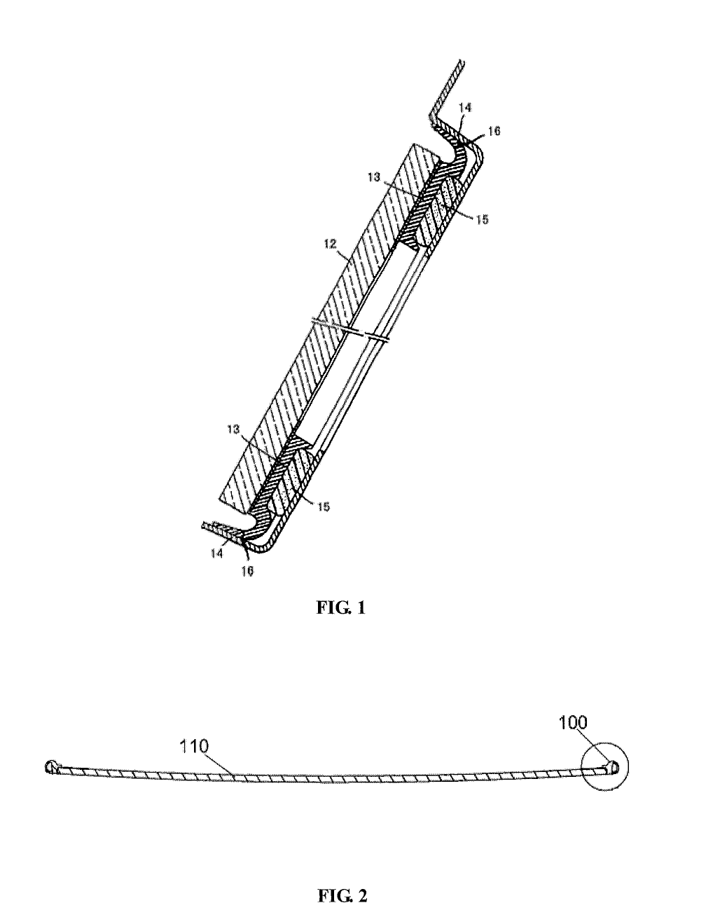

Referring to FIG. 1, when the deformable lip 16 in the existing techniques becomes curved, a channel framed by the deformable lip 16 is formed. In the embodiment, by using the sealing element 100, no channel is formed between the glass substrate 110 and the sheet metal 120. Therefore, wind noise caused by a channel may be avoided, and no space is left for receiving pollution, such as rains.

In some embodiments, the sealing element 100 may be made by double injection molding. In some embodiments, the double injection molding may include: injecting a first thermoplastic material into a mold cavity for forming the sealing element 100, so as to form the sealing part 132; and then injecting a second thermoplastic material into the mold cavity to form the supporting part 131, where the first thermoplastic material has a relative great flexibility while the second thermoplastic material has a relative small flexibility.

The material and forming processes of the sealing part 132 and the supporting part 131 are not limited to above embodiments.

In some embodiments, the sealing part 132 and the supporting part 131 may be made of a same material, and the sealing part 132 may be configured to have a thickness smaller than a thickness of the supporting part 131, so that the flexibility of the sealing part 132 is greater than that of the supporting part 131. When contacting with the sheet metal 120, the sealing part 132 is prone to deform, thereby realizing sealing the gaps between the glass substrate 110 and the sheet metal 120.

In some embodiments, both the sealing part 132 and the supporting part 131 may include thermoplastic elastomer, which reduces the number of material types and cost of materials. In some embodiments, the sealing element 100 may be formed by extrusion molding.

In some embodiments, the windshield may further include a second adhering film (not shown in figures) formed on an outer surface of the sealing part 132. The second adhering film is adapted for adhering the sealing part 132 to the sheet metal 120. In some embodiments, the second adhering film may not be formed.

Referring to FIGS. 3 and 4, the supporting part 131 and the sealing part 132 defines therebetween a space 133 to allow the sealing part 132 to deform when the windshield is being fixed into the opening.

Compared to the space 133 before installation shown in FIG. 3, the space 133 after installation shown in FIG. 4 has a smaller size along an extension direction of the glass substrate 110, as the space 133 is adapted for receiving deformation of the sealing part 132 caused by being squeezed by the sheet metal 120 when the windshield is being fixed into the opening.

In some embodiments, the sealing part 132 may deform when contacting with the sheet metal 120. The space 133 provides enough deformation space for the deformation of the sealing part 132, thereby providing installation tolerance for the windshield.

In some embodiments, even when a size or a shape of the glass substrate 110 does not exactly match a size or a shape of the opening, the deformation space provided by the space 133 may enable the sealing element 100 to seal the gaps between the glass substrate 110 and the sheet metal 120, thereby realizing sealing the windshield.

Therefore, compared with the existing techniques, requirements on the accuracy of the size or shape of the glass substrate 110 during its fabricating process may not be so strict, which simplifies the fabricating process of the glass substrate 110 and further simplifies a fabricating process of the windshield.

Further, compared with the existing techniques, as the space 133 provides the installation tolerance, the windshield is easier to be fixed in the opening framed by the sheet metal 120. Namely, the installation of the windshield is simpler.

In the embodiment, viewing from a cross-sectional perspective of the windshield, the space 133 is closed. The closed space 133 may enable the sealing part 132 to have relative large supporting force when it deforms, therefore, excessive deformation of the sealing part 132 may be avoided when the windshield is being fixed into the opening.

It should be noted that, in above embodiments, the gaps between the glass substrate 110 and the sheet metal 120 are sealed by the deformed sealing part 132, thereby reaching good effect of sealing the windshield.

Furthermore, considering the noise insulation effect, noise transmitting from an exterior to an interior of the vehicle will be blocked by a two-layer structure, i.e., a first half of the sealing part 132 facing outwardly and a second half of the sealing part 132 facing inwardly. And the space between the two layers, i.e., the space 133, is filled with air, which further improve the noise insulation effect.

Therefore, the sealing element 100 may not only ensure good sealing effect but also provide good sound insulation effect. That is, the windshield in the embodiment may reduce noises.

In the above embodiments, the supporting part 131 is secured to the edge of the glass substrate 110 through the first adhering film. It should be noted that, the way for securing the supporting part 131 to the glass substrate 110 is not limited to above embodiments. In some embodiments, the supporting part 131 may be formed at the edge of the glass substrate 110 directly by injection molding. In some embodiments, the supporting part 131 includes a slot at a side thereof facing toward the glass substrate 110 and is secured to the edge of the glass substrate 110 using the slot in a mechanical clamping way. In some embodiments, the slot may be a L-shape slot with two surfaces contacting with the edge of the glass substrate 110 or a U-shape slot with three surfaces contacting with the edge of the glass substrate 110.

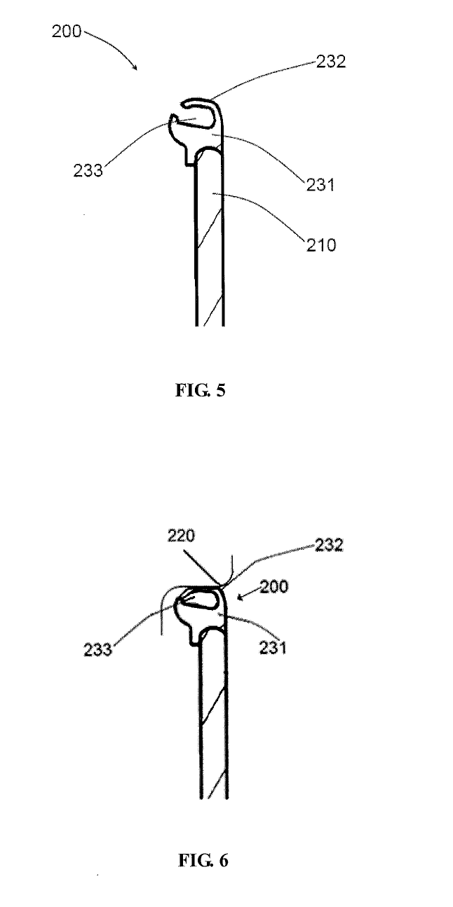

FIG. 5 schematically illustrates a second example of a sealing element included in the windshield shown in FIG. 2 before installation, and FIG. 6 schematically illustrates the sealing element shown in FIG. 5 after installation. Similar features between the first example and the second example will not be described here while the difference therebetween is described hereinafter.

Referring to FIGS. 5 and 6, viewing from a cross-sectional perspective of the windshield, a sealing part 232 includes a cutout at one end thereof separating one end of the sealing part 232 from a supporting part 231 and a space 233 defined between the supporting part 231 and the sealing part 232 is open.

With the cutout, the sealing part 232 is substantially configured as a cantilever structure. Compared with the sealing part 132 in FIG. 3, the sealing part 232 may have greater flexibility and thus can deform more easily.

Further, no material is required at the cutout, thus, material consumption of the sealing element 200 is reduced, namely, the cost of the material is reduced.

Referring to FIG. 6, in the embodiment, when the windshield is being fixed into an opening framed by a sheet metal 220, the sealing part 232 contacts with a sheet metal 220 and deforms, so that the end of the sealing part 232 where the cutout is formed contacts with the supporting part 231. That is to say, the space 233 is closed due to the deformation of the sealing part 232 when the windshield is being fixed into the opening framed by the sheet metal 220.

Embodiments of the present disclosure are not limited to above description. When the windshield is being fixed into the opening, if the deformation of the sealing part 232 is relatively small, the end of the sealing part 232 where the cutout is formed may not contact with the supporting part 231, that is, the space 233 is still open.

Referring to FIG. 6, after the windshield is fixed into the opening, the cutout is located at an end of the sealing part adjacent to an interior of the vehicle, which may prevent rains from entering into the space 233 through the cutout so as to ensure a service lifetime of the sealing element 200. It should be noted that, the location of the cutout is not limited to above description. In some embodiments, the cutout may be located at an end of the sealing part adjacent to an exterior of the vehicle.

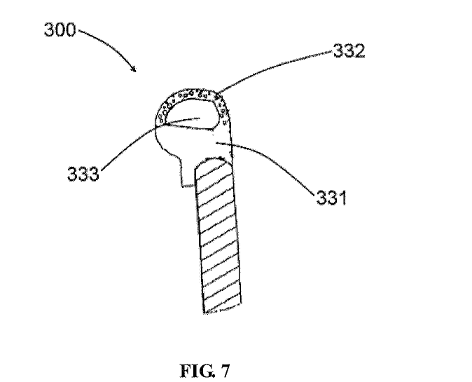

FIG. 7 schematically illustrates a third example of a sealing element included in the windshield shown in FIG. 2 before installation. Similar features between the first example and the third example will not be described here while the difference therebetween is described hereinafter.

Referring to FIG. 7, a sealing part 332 has a plurality of micropores. Therefore, the sealing part 332 may be softer than a supporting part 331, namely, the sealing part 332 has greater flexibility than that of the supporting part 331 and thus can deform more easily.

Besides, the sealing element 300 may be relatively lighter due to the micropores, which reduces a weight of the windshield.

In some embodiments, the sealing element 300 may be made by double injection molding which includes a first injection molding process for forming the supporting part 331 and a second injection molding process for forming the sealing part 332. During the second injection molding process, gases may be injected into a solution used in the injection, so that the plurality of micropores are generated in the sealing part 332 using microcellular foaming technology. The method for forming the plurality of micropores is not limited to above embodiment. In some embodiments, the plurality of micropores may be formed in other ways.

It should be noted that, if the micropores are oversized, open micropores may be formed on a surface of the sealing part 332, which influences the appearance of the sealing element 300. If the micropores are undersized, the sealing part 332 may not be soft enough, which results in an inadequate installation tolerance. In some embodiments, the micropores may have a diameter within a range from 0.01 mm to 1 mm, for example, 0.01 mm, 0.1 mm, 0.5 mm, 0.8 mm or 1 mm.

Accordingly, in an embodiment, a sealing element, for use with a windshield adapted for being fixed into an opening framed by a bodywork of a vehicle, is provided. The windshield includes a glass substrate. The sealing element includes a supporting part secured to an edge of the glass substrate; and a sealing part being integrated with the supporting part, viewing from a cross-sectional perspective of the windshield, the sealing part being substantially configured with a semicircle or semielliptical shape, wherein the supporting part and the sealing part define therebetween a space to allow the sealing part to deform when being fixed into the opening.

Detailed information about a structure and a material of the sealing element can be found in above description for embodiments of the windshield and is not described in detail here.

From embodiments of the present disclosure, the sealing element may provide installation tolerance for the windshield, thereby decreasing difficulty of fabricating the windshield. Besides, the sealing element may improve alignment when the windshield is being fixed into the opening framed by the bodywork of the vehicle.

From embodiments of the present disclosure, a surface of the sealing part which faces toward the exterior of the vehicle may be aligned with the surface of the sheet metal. Therefore, the appearance of the vehicle may be better, wind noise may be reduced, and spaces for accumulating rains or pollution may be eliminated.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure. Therefore, the protection scope of the present disclosure is subject to the scope defined by the claims.

What is claimed is:

1. A windshield, adapted for being fixed into an opening framed by a bodywork of the vehicle, comprising:
a glass substrate; and
a sealing element, including a supporting part secured to an edge of the glass substrate and a sealing part being integrated with the supporting part, viewing from a cross-sectional perspective of the windshield, the sealing part being substantially configured with a semicircle or semielliptical shape, and the supporting part and the sealing part defining therebetween a space to allow the sealing part to deform when being fixed into the opening.

2. The windshield of claim 1, wherein, viewing from a cross-sectional perspective of the windshield, the space is closed.

3. The windshield of claim 1, wherein, viewing from a cross-sectional perspective of the windshield, the sealing part comprises a cutout at one end thereof separating the end of the sealing part from the supporting part and the space is open.

4. The windshield of claim 3, wherein after being fixed into the opening, the sealing part deforms to have the space closed.

5. The windshield of claim 1, wherein the sealing part is made of material softer relative to the material of the supporting part.

6. The windshield of claim 5, wherein the sealing element is made by double injection molding.

7. The windshield of claim 1, wherein the sealing part and the supporting part are made of the same material, and the thickness of the sealing part is smaller than the thickness of the supporting part.

8. The windshield of claim 7, wherein the sealing element is made by extrusion molding.

9. The windshield of claim 1, wherein the sealing part has a plurality of micropores.

10. The windshield of claim 1, wherein the sealing element comprises thermoplastic elastomer.

11. The windshield of claim 1, wherein the supporting part has a channel for receiving the edge of the glass substrate.

12. A sealing element for use with a windshield adapted for being fixed into an opening framed by a bodywork of a vehicle, the windshield comprising a glass substrate, the sealing element comprising:
a supporting part secured to an edge of the glass substrate; and
a sealing part being integrated with the supporting part, viewing from a cross-sectional perspective of the windshield, the sealing part being substantially configured with a semicircle or semielliptical shape,
wherein the supporting part and the sealing part define therebetween a space to allow the sealing part to deform when being fixed into the opening.

13. The sealing element of claim 12, wherein viewing from a cross-sectional perspective of the windshield, the space is closed.

14. The sealing element of claim 12, wherein viewing from a cross-sectional perspective of the windshield, the sealing part comprises a cutout at one end thereof separating the end of the sealing part from the supporting part and the space is open.

15. The sealing element of claim 14, wherein after being fixed into the opening, the sealing part deforms to have the space closed.

16. The sealing element of claim 12, wherein the sealing part is made of material softer relative to the material of the supporting part.

17. The sealing element of claim 16, wherein the sealing element is made by double injection molding.

18. The sealing element of claim 12, wherein the sealing part and the supporting part are made of the same material, and the thickness of the sealing part is smaller than the thickness of the supporting part.

19. The sealing element of claim 18, wherein the sealing element is made by extrusion molding.

20. The sealing element of claim 12, wherein the sealing part has a plurality of micropores.
